(19) United States
(12) Patent Application Publication
(10) Pub. No.: US 2025/0355389 A1
(43) Pub. Date: Nov. 20, 2025

(54) FIXING DEVICE AND IMAGE FORMING APPARATUS INCORPORATING SAME

(71) Applicants: Takahiro IMADA, Kanagawa (JP); Haruki OZAWA, Kanagawa (JP)

(72) Inventors: Takahiro IMADA, Kanagawa (JP); Haruki OZAWA, Kanagawa (JP)

(21) Appl. No.: 19/207,359

(22) Filed: May 14, 2025

(30) Foreign Application Priority Data
May 17, 2024 (JP) 2024-081274

(51) Int. Cl. G03G 15/20

(52) U.S. Cl. CPC G03G 15/2053; G03G 15/2064

(57) ABSTRACT

A fixing device includes a belt, an opposed rotator, a heater, a holder, and a support. The opposed rotator contacts an outer circumferential surface of the belt to form a nip. The heater heats the belt. The holder holds the heater and extends in a longitudinal direction. The support supports an end of the belt in the longitudinal direction and has a widened portion. The holder widens the widened portion of the support.

### CROSS-REFERENCE TO RELATED APPLICATIONS

This patent application is based on and claims priority pursuant to 35 U.S.C. § 119(a) to Japanese Patent Application No. 2024-081274, filed on May 17, 2024, in the Japan Patent Office, the entire disclosure of which is hereby incorporated by reference herein.

### BACKGROUND

### Technical Field

The present disclosure relates to a fixing device and an image forming apparatus incorporating the fixing device.

### Related Art

One type of image forming apparatus includes a fixing device. The fixing device includes a frame, a heating device including a heater, a fixing belt, and a flange supporting both ends of the fixing belt in a longitudinal direction of the fixing belt. The frame has openings at both sides of the frame in the longitudinal direction. Both ends of the flange in a transverse direction of the heater are fitted to each of the openings of the flange, and the heating device is slid along a thickness direction of the heater and inserted into the openings.

### SUMMARY

The present disclosure described herein provides a fixing device including a belt, an opposed rotator, a heater, a holder, and a support. The opposed rotator contacts an outer circumferential surface of the belt to form a nip. The heater heats the belt. The holder holds the heater and extends in a longitudinal direction. The support supports an end of the belt in the longitudinal direction and has a widened portion. The holder widens the widened portion of the support.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a schematic cross-sectional view of a fixing device;

FIG. 3 is a schematic perspective view of a portion around a flange;

FIG. 4A is a schematic side view of the flange of FIG. 3;

FIG. 4B is a schematic side view of the heater holder of FIG. 3;

FIG. 5 is a schematic sectional view of a part of a heater holder and a part of a flange in a fixing device according to a second embodiment;

FIG. 6 is a schematic view of a part of a flange and a part of a heater holder in a fixing device according to a third embodiment.

FIG. 7 is a schematic view of a part of the flange and a part of a heater holder in a fixing device according to a fourth embodiment;

FIG. 8 is a schematic view of a part of a flange and a part of a heater holder in a fixing device according to a fifth embodiment;

FIG. 9 is a schematic view of a fixing device including a bridging portion and a ball bearing;

FIG. 10 is a schematic perspective view of the fixing device of FIG. 9;

FIG. 11 is a schematic view of a sliding bearing;

FIG. 12A is a schematic view of a flange as viewed in a rotational axis direction of a fixing belt;

FIG. 12B is a schematic view of the flange of FIG. 12A deformed as viewed in the rotational axis direction of the fixing belt;

FIG. 13(a) and FIG. 13(b) are schematic views each illustrating a pressure roller, a heater, a heater holder, a stay, a flange, and a frame in a fixing device;

FIG. 14 is a schematic view of a flange including a belt slide having an opening to illustrate deformation due to the opening; and

FIG. 15 is a schematic view of a flange including a bridging portion that prevents a U-shape of the flange from closing inward.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

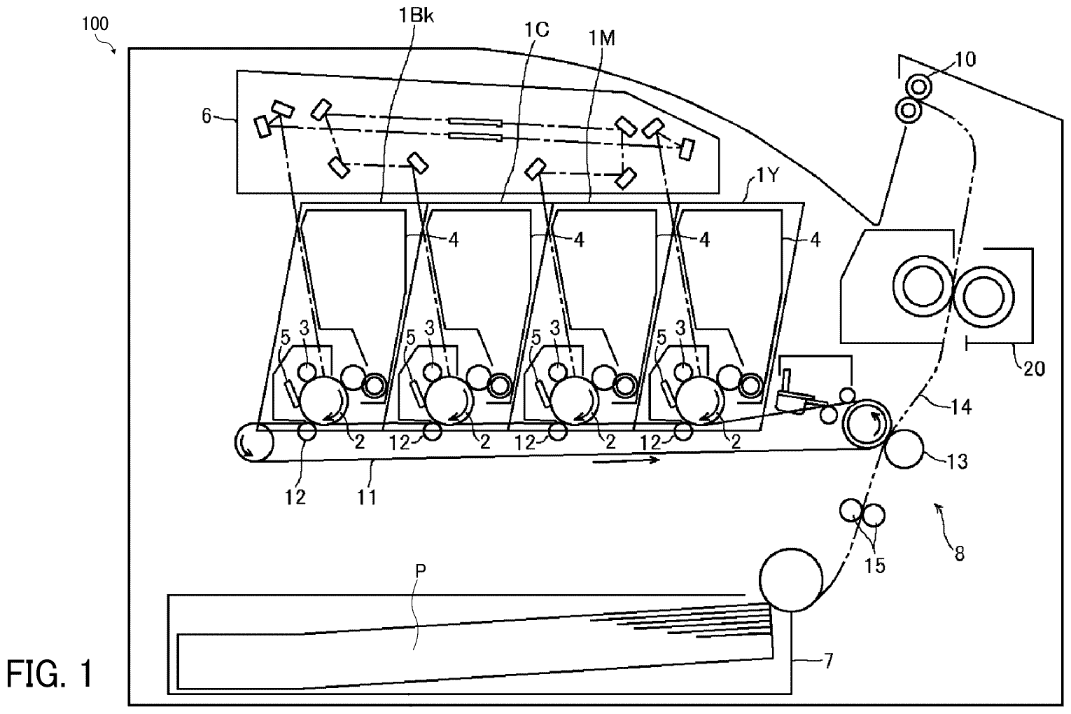

FIG. 1 is a schematic diagram of the configuration of the image forming apparatus. The image forming apparatus is a printer. Alternatively, the image forming apparatus may be a copier, a facsimile machine, a multifunction peripheral (MFP) having at least two of printing, copying, facsimile, scanning, and plotter functions.

As illustrated in FIG. 1, an image forming apparatus 100 includes four image forming units 1Y, 1M, 1C, and 1Bk serving as image forming devices, respectively. The image forming units 1Y, 1M, 1C, and 1Bk are removably installed in the body of the image forming apparatus 100. The image forming units 1Y, 1M, 1C, and 1Bk have a similar configuration except that the image forming units 1Y, 1M, 1C, and 1Bk contain developers in different colors, that is, yellow, magenta, cyan, and black, respectively, which correspond to color separation components for a color image. Specifically, each of the image forming units 1Y, 1M, 1C, and 1Bk includes a photoconductor 2 that is drum-shaped and serves as an image bearer, a charging device 3 to charge the surface of the photoconductor 2, a developing device 4 to supply toner as a developer to the surface of the photoconductor 2 to form a toner image, and a cleaner 5 to clean the surface of the photoconductor 2.

The image forming apparatus 100 further includes an exposure device 6, a sheet feeder 7, a transfer device 8, a fixing device 9, and a sheet ejection device 10. The exposure device 6 exposes the surface of each of the photoconductors 2 and forms an electrostatic latent image on the surface of each of the photoconductors 2. The sheet feeder 7 supplies a sheet P serving as a recording medium to the transfer device 8. The transfer device 8 transfers the toner image formed on each of the photoconductors 2 onto the sheet P. The fixing device 9 fixes the toner image transferred onto the sheet P thereon. The sheet ejection device 10 ejects the sheet Ponto an outside of the image forming apparatus 100.

The transfer device 8 includes an intermediate transfer belt 11, four primary transfer rollers 12, and a secondary transfer roller 13. The intermediate transfer belt 11 is an endless belt serving as an intermediate transferor stretched taut across a plurality of rollers. The four primary transfer rollers 12 serve as primary transferors that transfer yellow, magenta, cyan, and black toner images formed on the photoconductors 2 onto the intermediate transfer belt 11, respectively, thus forming a full color toner image on the intermediate transfer belt 11. The secondary transfer roller 13 serves as a secondary transferor that transfers the full color toner image formed on the intermediate transfer belt 11 onto the sheet P. The four primary transfer rollers 12 are in contact with the respective photoconductors 2 via the intermediate transfer belt 11. Thus, the intermediate transfer belt 11 contacts each of the photoconductors 2, forming a primary transfer nip therebetween. The secondary transfer roller 13 contacts, via the intermediate transfer belt 11, one of the plurality of rollers around which the intermediate transfer belt 11 is stretched. Thus, the secondary transfer nip is formed between the secondary transfer roller 13 and the intermediate transfer belt 11.

The image forming apparatus 100 includes a sheet conveyance path 14 through which the sheet P fed from the sheet feeder 7 is conveyed. A timing roller pair 15 is disposed at a position between the sheet feeder 7 and the secondary transfer nip defined by the secondary transfer roller 13 in the sheet conveyance path 14.

Referring to FIG. 1, a description is provided of printing processes performed by the image forming apparatus 100 described above.

When the image forming apparatus 100 receives an instruction to start printing, a driver drives and rotates the photoconductor 2 clockwise in FIG. 1 in each of the image forming units 1Y, 1M, 1C, and 1Bk. The charging device 3 charges the surface of the photoconductor 2 uniformly at a high electric potential. Subsequently, the exposure device 6 exposes the surface of each of the photoconductors 2 based on image data created by a document reading device that reads an image on an original or print data instructed by a terminal, thus decreasing the electric potential of an exposed portion on the photoconductor 2 and forming an electrostatic latent image on the photoconductor 2. The developing device 4 supplies toner to the electrostatic latent image formed on the photoconductor 2, forming a toner image thereon.

The toner images formed on the photoconductors 2 reach the primary transfer nips defined by the primary transfer rollers 12 with the rotation of the photoconductors 2 and are transferred onto the intermediate transfer belt 11 driven and rotated counterclockwise in FIG. 1 successively such that the toner images are superimposed on the intermediate transfer belt 11, forming a full color toner image thereon. The full-color toner image on the intermediate transfer belt 11 is conveyed to the secondary transfer nip defined by the secondary transfer roller 13 as the intermediate transfer belt 11 rotates. At the secondary transfer nip, the full-color toner image is transferred onto the sheet P conveyed to the secondary transfer nip. The sheet P is supplied from the sheet feeder 7. The timing roller pair 15 temporarily halts the sheet P supplied from the sheet feeder 7. Then, the timing roller pair 15 conveys the sheet P to the secondary transfer nip at a time when the full color toner image formed on the intermediate transfer belt 11 reaches the secondary transfer nip. Thus, the full-color toner image is transferred onto and borne on the sheet P. After the toner image is transferred from each of the photoconductors 2 onto the intermediate transfer belt 11, each of cleaners 5 removes residual toner on each of the photoconductors 2.

After the full color toner image is transferred onto the sheet P, the sheet P is conveyed to the fixing device 9 to fix the full color toner image onto the sheet P. Thereafter, the sheet ejection device 10 ejects the sheet P onto the outside of the image forming apparatus 100, thus finishing a series of printing processes.

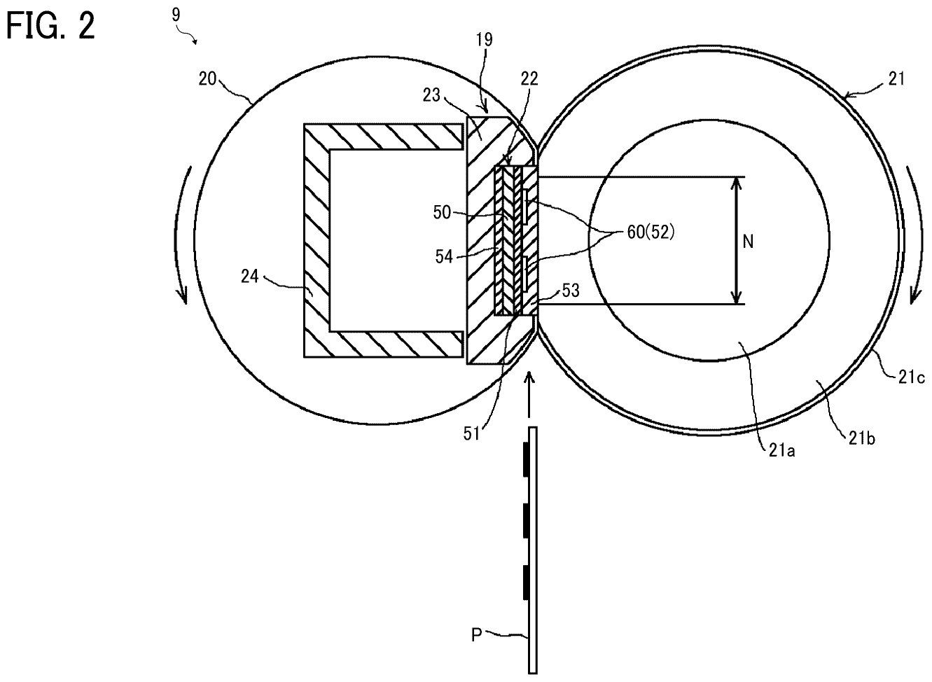

A description is given of the configuration of the fixing device 9, with reference to FIG. 2.

As illustrated in FIG. 2, the fixing device 9 according to this embodiment includes a fixing belt 20, a pressure roller 21, and a heating device 19. The fixing belt 20 is an endless belt serving as a fixing rotator or a fixing member. The pressure roller 21 serves as an opposed rotator or an opposed member that contacts an outer circumferential surface of the fixing belt 20 to form a fixing nip N between the fixing belt 20 and the pressure roller 21. The heating device 19 heats the fixing belt 20. The heating device 19 includes a heater 22, a heater holder 23, and a stay 24. The heater 22 is a planar or laminated heater and serves as a heater or a heating member. The heater holder 23 serves as a holder that holds or supports the heater 22. The stay 24 serves as a reinforcement that reinforces the heater holder 23 throughout an entire width of the heater holder 23 in a longitudinal direction thereof.

The fixing belt 20 includes a tubular base that is made of polyimide (PI) and has an outer diameter of 25 mm and a thickness in a range of 40 μm to 120 μm, for example. The fixing belt 20 further includes a release layer serving as an outermost surface layer. The release layer is made of fluororesin, such as tetrafluoroethylene-perfluoroalkylvinylether copolymer (PFA) or polytetrafluoroethylene (PTFE) and has a thickness in a range of 5 μm to 50 μm to enhance the durability of the fixing belt 20 and facilitate separation of the sheet P and a foreign substance from the fixing belt 20. An elastic layer made of rubber having a thickness of from 50 to 500 μm may be interposed between the base and the release layer. The base of the fixing belt 20 may be made of heat-resistant resin such as polyetheretherketone (PEEK) or metal such as nickel (Ni) and steel use stainless (SUS), instead of polyimide. The inner circumferential surface of the fixing belt 20 may be coated with PI or PTFE as a slide layer.

The pressure roller 21 having, for example, an outer diameter of 25 mm, includes a solid iron core 21a, an elastic layer 21b formed on the surface of the core 21a, and a release layer 21c formed on the outside of the elastic layer 21b. The elastic layer 21b is made of silicone rubber and has a thickness of 3.5 mm, for example. Preferably, the release layer 21c is formed by a fluororesin layer having, for example, a thickness of approximately 40 μm on the surface of the elastic layer 21b to enhance releasability.

The heater 22 extends in a longitudinal direction thereof throughout an entire width of the fixing belt 20 in the width direction of the fixing belt 20. The heater 22 is disposed so as to contact the inner circumferential surface of the fixing belt 20. The heater 22 may not contact the fixing belt 20 or may be in indirect contact with the fixing belt 20 via a low-friction sheet. However, the heater 22 in direct contact with the fixing belt 20 enhances conduction of heat from the heater 22 to the fixing belt 20. The heater 22 may contact the outer circumferential surface of the fixing belt 20. However, if the outer circumferential surface of the fixing belt 20 is brought into contact with the heater 22 and damaged, the fixing belt 20 may degrade the quality of fixing the toner image on the sheet P. For this reason, preferably, the heater 22 contacts the inner circumferential surface of the fixing belt 20. The heater 22 includes a base layer 50, a first insulating layer 51, a conductor layer 52, a second insulating layer 53, and a third insulating layer 54. The first insulating layer 51, the conductor layer 52, and the second insulating layer 53 are layered on the base layer 50 in this order and sandwiched between the base layer 50 and the fixing nip N. The conductor layer 52 includes a heat generator 60. The third insulating layer 54 is layered on the base layer 50 and is disposed opposite the fixing nip N via the base layer 50.

A detailed description is now given of the construction of the heater holder 23 and the stay 24. The heater holder 23 and the stay 24 are disposed inside a loop formed by the fixing belt 20. The stay 24 includes a channel made of metal. Both lateral ends of the stay 24 in a longitudinal direction thereof are supported by side walls of the fixing device 9. The stay 24 supports a stay-side face of the heater holder 23 that faces the stay 24 and is opposite a heater-side face of the heater holder 23 that faces the heater 22. Accordingly, the stay 24 retains the heater 22 and the heater holder 23 so that the heater 22 and the heater holder 23 are not substantially bent by the pressure from the pressure roller 21, thus forming the fixing nip N between the fixing belt 20 and the pressure roller 21.

Since the heater holder 23 is heated to a high temperature by heat from the heater 22, the heater holder 23 is preferably made of a heat resistant material. The heater holder 23 is made of heat-resistant resin having low thermal conduction, such as a liquid crystal polymer (LCP) or polyether ether ketone (PEEK) and reduces heat transfer from the heater 22 to the heater holder 23 and provides efficient heating of the fixing belt 20.

A spring serving as a biasing member causes the fixing belt 20 and the pressure roller 21 to press against each other. Thus, the fixing nip N is formed between the fixing belt 20 and the pressure roller 21.

As a driving force is transmitted to the pressure roller 21 from a driver disposed in the body of the image forming apparatus 100, the pressure roller 21 serves as a driving roller that drives and rotates the fixing belt 20. The fixing belt 20 is driven and rotated by the pressure roller 21 as the pressure roller 21 rotates. While the fixing belt 20 rotates, the fixing belt 20 slides over the heater 22. In order to facilitate sliding performance of the fixing belt 20, a lubricant such as oil or grease may be interposed between the heater 22 and the fixing belt 20.

When printing starts, the driver drives and rotates the pressure roller 21, and the fixing belt 20 starts rotation in accordance with rotation of the pressure roller 21. Additionally, as power is supplied to the heater 22, the heater 22 heats the fixing belt 20. The sheet P bearing the unfixed toner image is conveyed through the fixing nip N between the fixing belt 20 having the temperature that has reached a predetermined target temperature (which is referred to as a fixing temperature) and the pressure roller 21 as illustrated in FIG. 2, and applying heat and pressure to the unfixed toner image fixes the unfixed toner image onto the sheet P.

Comparative examples are described with reference to FIGS. 12A to 15. The image forming apparatus according to the comparative example includes the fixing device, and the fixing device includes flanges. The flange is made of resin and has a substantially U-shape as viewed in the rotational axis direction of the fixing belt as illustrated in FIG. 12A. In the above-described structure, contraction during molding of the flange, a pressing force received from the pressure roller, or thermal deformation may deform the flange so that the tips of the U-shape are closed as illustrated in FIG. 12B.

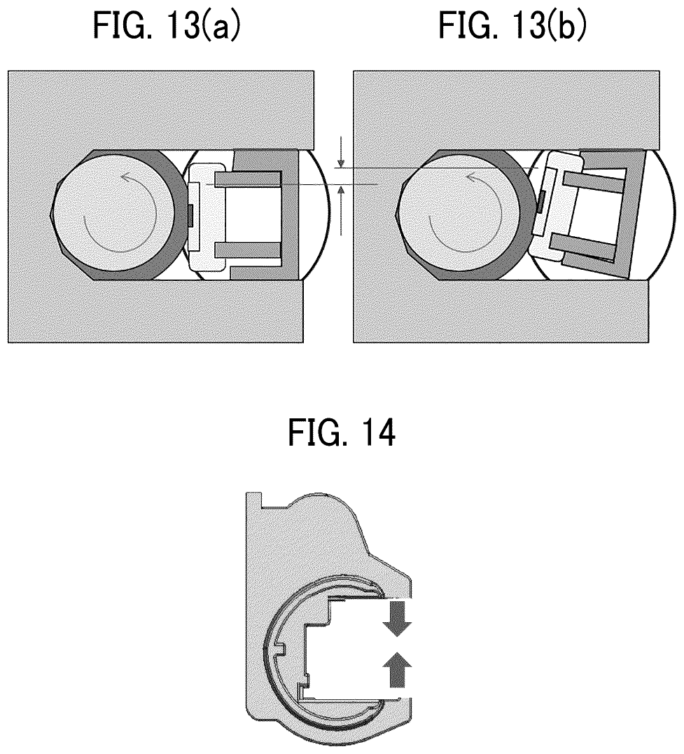

As illustrated in FIG. 13(a), in the fixing device of the comparative example, the heater is positioned by the heater holder, the heater holder is positioned by the stay, the stay is positioned by the flange, and the flange is positioned by the frame. As a result, the deformation of the flange shifts the position of the heater from the target position as illustrated in FIG. 13(b). If the position of the heater is shifted, the heat of the heater is not well transferred to the fixing belt, and a fixing failure may occur. In addition, the heater may be partially overheated and broken by thermal stress.

The deformation of the flange causes not only the inclination of the flange but also deformation of a belt slide of the flange, on which the fixing belt slides, so as to be deformed in a direction closing a U-shape of the belt slide as illustrated in FIG. 14, which causes the fixing belt to flutter during driving. As a result, the belt traveling property is not stabilized, and the fixing belt may be damaged.

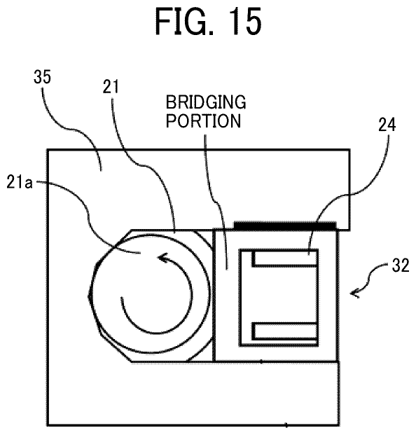

To prevent the U-shape of the flange from closing inward, placing a bridging portion between the tips of the U-shape as illustrated in FIG. 15 may be considered. In this case, the bridging portion disposed on the flange forms a substantially square shape as viewed in the rotational axis direction of the fixing belt.

However, the flange having the bridging portion has the following disadvantages.
(1) Forming the bridging portion limits the direction to assemble a component to the flange or another component around the flange.
(2) Forming the bridging portion increases the amount of resin that is the material of the flange, which increases the material cost and the component cost.
(3) Since the fixing belt and the heater in contact with the fixing belt are in the opening of the U-shaped portion of the belt slide on which the fixing belt slides, the bridging portion cannot be disposed on the belt slide. Even if the bridging portion is disposed in another portion of the flange, the belt slide is slightly deformed so as to be closed inward.

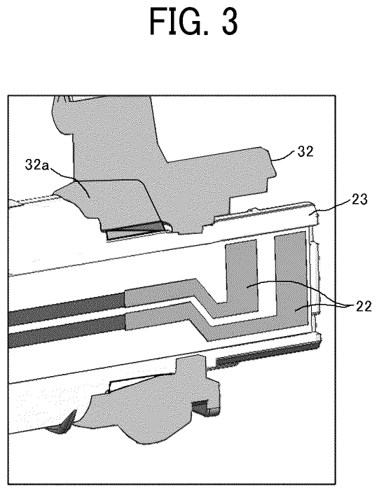

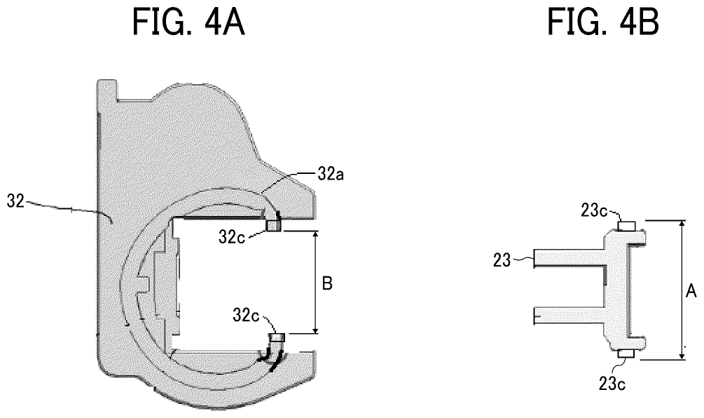

With reference to FIGS. 3 and 4, the structure regarding the flange according to a first embodiment of the present disclosure is described below. FIG. 3 is a schematic perspective view of a portion around a flange 32. FIG. 4A is a schematic side view of the flange 32, and FIG. 4B is a schematic side view of the heater holder 23.

The fixing device according to the first embodiment includes flanges 32 adjacent to both ends of the fixing belt 20 in the rotational axis direction of the fixing belt 20. The rotational axis direction of the fixing belt 20 is the same as the longitudinal direction of at least one of the stay 24, the heater 22, and the heater holder 23. As illustrated in FIG. 3, the flange 32 functions as a support supporting one end of each of the stay 24, the heater 22 and the heater holder 23 in the rotational axis direction. The flanges 32 are fitted to both ends of a subassembly including the stay 24 and the heater holder 23 and hold both ends of the stay 24, the heater 22, and the heater holder 23 in the rotational axis direction. The flanges 32 are inserted into the loops of the fixing belt 20 at both ends in the rotational axis direction and are in contact with the inner peripheral surface on both sides of the fixing belt 20 to guide the rotation of the fixing belt 20. The flange 32 supports an end of the fixing belt 20 in the rotational axis direction. When the fixing belt 20 moves in the rotational axis direction, one of both ends of the fixing belt 20 comes into contact with one of the flanges 32, which prevents the fixing belt 20 from further moving in the rotational axis direction. In other words, the flanges 32 function as belt holders. The flanges 32 are inserted into openings in both side plates of the fixing device, slide on edges of the openings, and are set to both side plates of the fixing device.

The flange 32 has no bridging portion and has a substantially U-shape as viewed in the rotational axis direction of the fixing belt 20. In the present embodiment, when the flange 32 is assembled to the heater holder 23, the U-shaped flange 32 is partially widened by the heater holder 23. In other words, the shape of the flange 32 is determined by the heater holder 23. As a result, the heater holder 23 serves as a stopper to prevent the flange 32 from closing inward when the heater holder 23 and the flange 32 are assembled, specifically, to prevent the flange 32 from being deformed when being pressurized or thermally deformed.

As illustrated in FIG. 3, the flange 32 has a belt slide 32a on which the inner circumferential surface of the end portion of the fixing belt in the rotational axis direction slides. FIG. 4A is the schematic side view of the flange 32 of FIG. 3 before being assembled, as viewed in the rotational axis direction. FIG. 4B is the schematic side view of the heater holder 23 of FIG. 3 before being assembled, as viewed in the rotational axis direction. In other words, the heater holder 23 is not disposed inside the flange 32.

The belt slide 32a of the flange 32 has an opening and projections 32c at edges of the opening. The heater holder 23 has projections 23c as widening portions on both ends of the heater holder 23 in a transverse direction orthogonal to the longitudinal direction of the heater holder 23. As illustrated in FIG. 3, the edge of the opening of the belt slide 32a extends in the longitudinal direction of the heater holder 23, and the projection 32c as a widened portion is located at least in a part of the edge of the opening. The projection 23c as the widening portion of the heater holder 23 is disposed such that at least a part of the projection 23c overlaps and contacts at least a part of the projection 32c as the widened portion after the flange 32 is assembled to the heater holder 23. The projection 23c forms the longest portion of the heater holder 23 in the transverse direction of the heater holder 23 and has a length A in the transverse direction. The projections 32c form the narrowest part of the opening of the belt slide 32a, and the opening has a length B in the transverse direction at a position at which the projection 23c contacts the projection 32c. The heater holder 23 and the flange 32 are designed so that the length A is longer than the length B when the heater holder 23 and the flange 32 are not assembled. In other words, the heater holder 23 and the flange 32 are designed so that the longest length of the heater holder 23 in the transverse direction is longer than the narrowest length of the opening of the belt slide in the transverse direction when the heater holder 23 and the flange 32 are not assembled. Assembling the flange 32 to the heater holder 23 elastically deforms the belt slide 32a of the flange 32 and slightly widens the belt slide 32a. As a result, the heater holder 23 supports the edges of the opening of the belt slide 32a, which prevents the belt slide 32a from being deformed to be closed by the pressure or heat.

In other words, the flange 32 as the support has the belt slide 32a having the opening and the projection 32c as the widened portion at least in a part of an edge of the opening. The heater holder 23 includes the projection 23c as the widening portion in a part of the heater holder 23 in the longitudinal direction of the heater holder23. The projection 23c contacts the projection 32c and widens the opening, in other words, widens the projection 32c as the widened portion. The projections 23c of the heater holder 23 not disposed inside the flange 32 as the support has the length A in the transverse direction orthogonal to the longitudinal direction and has the longest length in the transverse direction. The projection 32c as the widened portion of the flange, in which the heater holder is not disposed, has the length B in the transverse direction shorter than the length A at a position where the projection 23c contacts the projection 32c and has the shortest length of the opening in the transverse direction.

In addition, the heater holder 23 and the flange 32 are designed to satisfy the following relationship.

(A−B)≤0.1 mm.

This is because a too large value of (A−B) causes the difficulty in assembling the flange to the heater holder, and stress is applied to the parts during assembly, which causes breakage.

With reference to FIG. 3, when the flange 32 is assembled to the heater holder 23, the gap between the heater holder 23 and the flange 32 varies depending on the position of the flange 32 put on the heater holder 23. Specifically, the projection 23c forming the length A, the longest portion of the heater holder 23 in the transverse direction has a tapered shape, and the projection 32c forming the length B, the narrowest part of the opening of the belt slide 32a also has a tapered shape so as to engage the projection 23c of the heater holder 23. In other words, the projection 23c widening the flange as the support has a height changing in an insertion direction in which the flange 32 is inserted into the heater holder 23, and the projection 32c has a height changing in the insertion direction. When the flange 32 is inserted into the heater holder 23 from the right side to the left side in FIG. 3, the flange 32 and the heater holder 23 are not fixed but loosely engaged with each other at first, but when the flange 32 is inserted to the insertion end, the flange 32 is widened and is tightly fixed to the heater holder 23. As described above, the opening shape of the belt slide 32a of the flange 32 is fixed.

In other words, the fixing device has the following structure. The projection 23c forming the length A, that is, the longest portion of the heater holder 23 in the transverse direction has the tapered shape that tapers in the longitudinal direction of the heater holder 23. The projection 32c forming the length B, that is, the narrowest part of the opening of the belt slide 32a of the flange 32 also has the tapered shape that tapers in the longitudinal direction of the heater holder 23. As a result, when the flange 32 is inserted into the heater holder 23 from the right side to the left side in FIG. 3, the flange 32 and the heater holder 23 are not fixed but loosely engaged with each other at first, but when the flange 32 is inserted to the insertion end, the flange 32 is widened and is tightly fixed to the heater holder 23. As described above, the opening shape of the belt slide 32a of the flange 32 is fixed.

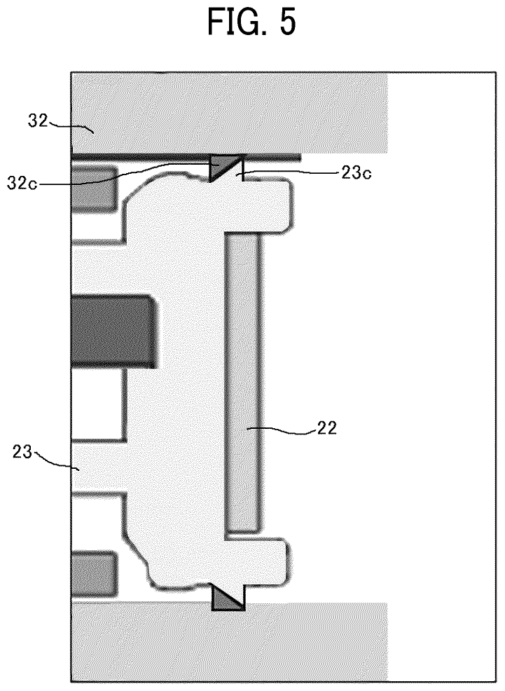

FIG. 5 is a schematic sectional view of a part of the heater holder 23 and a part of the flange 32 in a second embodiment.

The fixing device according to the second embodiment has the following structure. The projection 23c forming the length A, that is, the longest portion of the heater holder 23 in the transverse direction has a tapered shape that tapers in the direction orthogonal to the longitudinal direction and the transverse direction of the heater holder 23. The projection 32c forming the length B, that is, the narrowest part of the opening of the belt slide 32a of the flange 32 also has a tapered shape that tapers in the direction orthogonal to the longitudinal direction and the transverse direction of the heater holder 23. Specifically, the flange 32 includes the projection 32c inclined in the direction intersecting the longitudinal direction and the transverse direction of the heater holder 23, and the heater holder 23 includes the projection 23c inclined in the direction intersecting the longitudinal direction and the transverse direction of the heater holder 23. The projection 23c is engaged with the projection 32c. When viewed in the rotational axis direction of the fixing belt, the height of the projection 32c of the flange 32 gradually increases from the opening toward the stay 24 supporting the heater holder 23, whereas the height of the projection 23c of the heater holder 23 gradually decreases from the opening toward the stay 24. Unlike the embodiment of FIG. 3, the structure in the second embodiment enables the heater holder 23 to be assembled by moving the heater holder 23 from the right side to the left side in FIG. 5, that is, in the direction intersecting the longitudinal direction and the transverse direction of the heater holder 23 and inserting the heater holder 23 into the opening of the flange 32. In other words, the projection 23c widening the flange as the support has the height changing in an insertion direction in which the heater holder 23 is inserted into the flange 32, and the projection 32c has the height changing in the insertion direction.

In the embodiments of FIGS. 3 and 5, the projection 23c that determines the length A of the longest portion of the heater holder 23 in the transverse direction and the projection 32c that determines the length B of the narrowest part of the opening of the flange 32 each have the tapered shape. This facilitates assembly of the heater holder 23 and the flange 32.

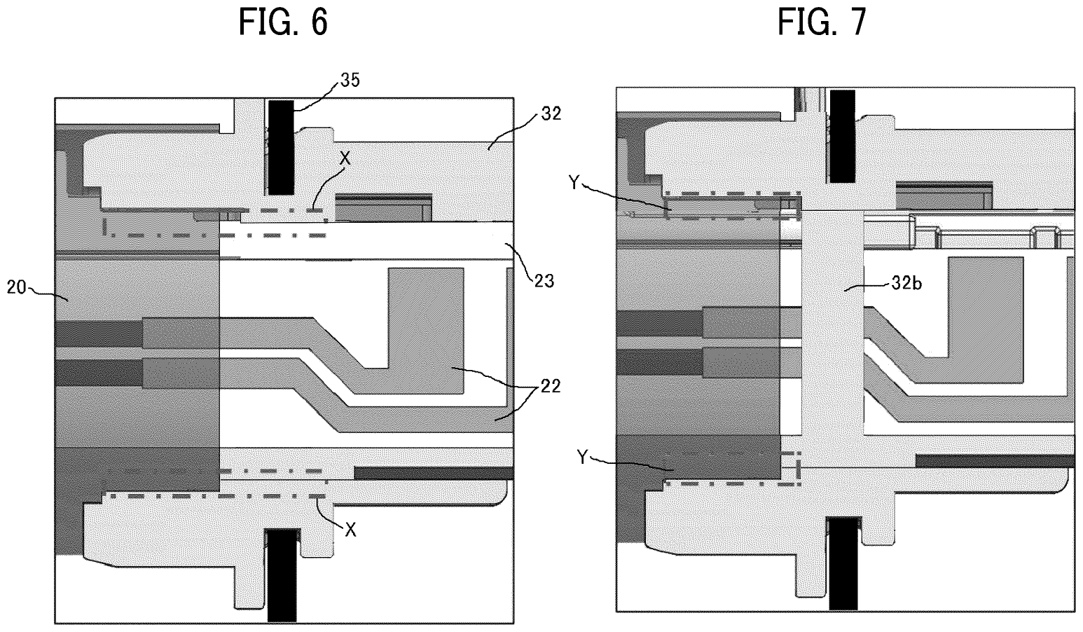

FIG. 6 is a schematic view of a part of the flange 32 and a part of the heater holder 23 in the fixing device according to a third embodiment.

A frame 35 is fitted to the flange 32 at a position outside the belt slide 32a of the flange 32 in the rotational axis direction of the fixing belt. The longest portion of the heater holder 23 in the transverse direction of the heater holder 23 is engaged with the narrowest part of the opening of the flange 32. The longest portion of the heater holder 23 in the transverse direction of the heater holder 23 and the narrowest part of the opening of the flange 32 are in a range X in FIG. 6. In the rotational axis direction, the range X is from a region along the belt slide 32a of the flange 32 to the position at which the frame 35 is fitted to the flange 32. As described with reference to FIG. 13(a) and FIG. 13(b), the deformed flange pressed against the pressure roller inclines the entire subassembly including the stay, the heater holder, and the heater. In order to prevent this, it is desirable that the longest portion of the heater holder 23 in the transverse direction of the heater holder 23 and the narrowest part of the opening of the flange 32 extend to the position adjacent to the frame 35.

FIG. 7 is a schematic view of a part of the flange 32 and a part of the heater holder 23 in the fixing device according to a fourth embodiment.

The flange 32 in the fourth embodiment includes a bridging portion 32b adjacent to the position at which the frame 35 is fitted to the flange 32. The longest portion of the heater holder 23 in the transverse direction and the narrowest part of the opening of the belt slide 32a are in a range Y in FIG. 7 along the belt slide 32a. The structure in the fourth embodiment further enhances the ease of assembly of the heater holder 23 and the flange 32 than the structure including the longest portion of the heater holder 23 in the transverse direction of the heater holder 23 and the narrowest part of the opening of the flange 32 that are in the range from a region along the belt slide 32a of the flange 32 to the position at which the frame 35 is fitted to the flange 32.

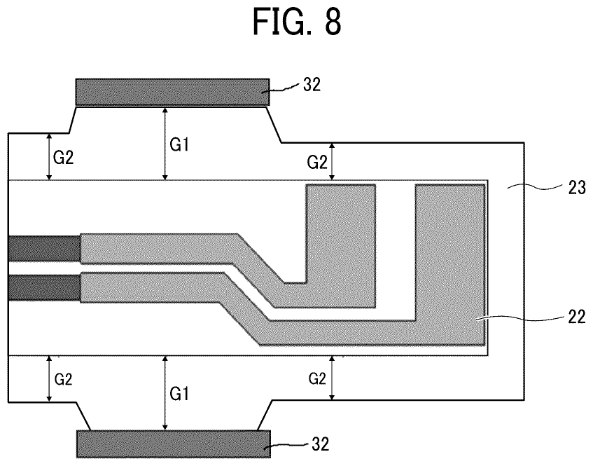

FIG. 8 is a schematic view of a part of the flange 32 and a part of the heater holder 23 in the fixing device according to a fifth embodiment.

As illustrated in FIG. 8, the heater holder 23 in the fifth embodiment is designed to have a gap G1 larger than a gap G2. The gap G1 is between the heater 22 and an edge of the heater holder 23 adjacent to the belt slide 32a, and the gap G2 is between the heater and the edge of the heater holder 23 in a region not being adjacent to the belt slide 32a. Widening the flange 32 and assembling the flange 32 to the heater holder 23 may slightly deform the heater holder 23.

To prevent the deformation of the heater holder 23 from affecting the heater 22, the longest portion of the heater holder 23 in the transverse direction that is engaged with the narrowest part of the opening of the flange 32 is designed to have the gap G1 larger than the gap G2.

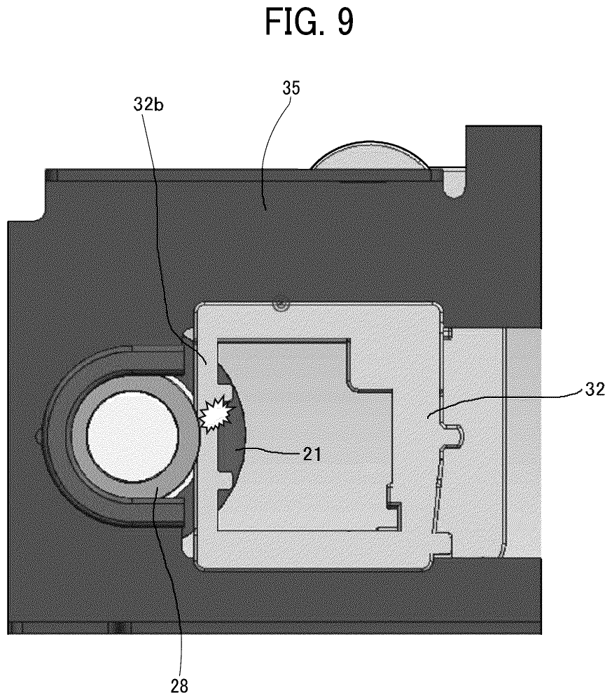

FIGS. 9 to 11 are schematic views to illustrate a disadvantage in the fixing device including the bridging portion 32b and a ball bearing 28.

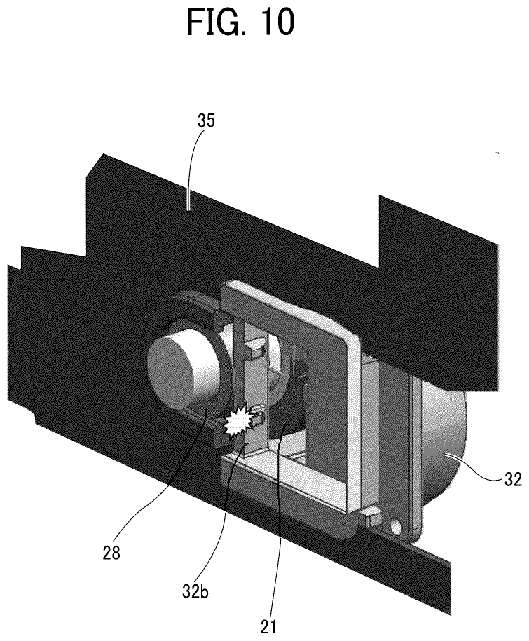

In FIGS. 9 and 10, the fixing device 9 includes the ball bearing 28 used as a bearing of the pressure roller 21. In other words, the fixing device 9 includes the ball bearing 28 receiving a shaft of the pressure roller 21 as the opposed rotator. As illustrated in FIGS. 9 and 10, the ball bearing 28 having a large outer diameter may contact the bridging portion 32b. From the viewpoint of the layout of the parts, which can avoid the above-described disadvantage, it is preferable that the longest portion of the heater holder 23 in the transverse direction engages with the narrowest part of the opening of the belt slide 32a to remove the bridging portion 32b.

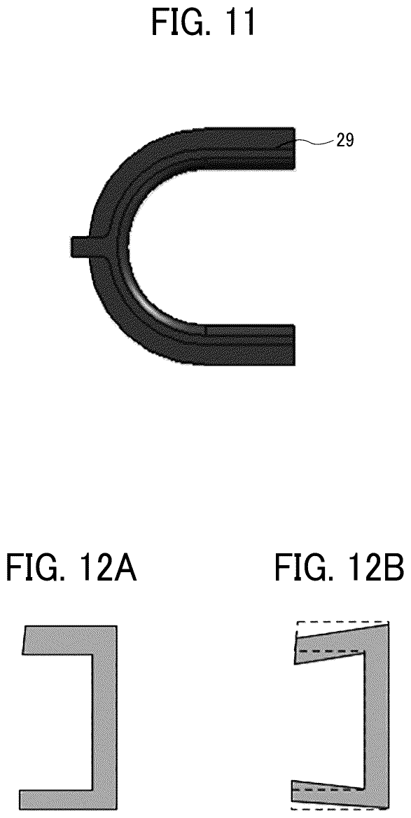

Without using the ball bearing, using a sliding bearing 29 having a U-shape as illustrated in FIG. 11 may be considered. Since the bridging portion 32b faces the opening of the sliding bearing 29, the bridging portion 32b does not contact the sliding bearing 29. However, replacing the sliding bearing 29 with the ball bearings 28 to enhance the durability may cause the bridging portion 32b to come into contact with the ball bearing 28 as described above. According to the embodiment of FIG. 3, the ball bearings 28 can be used as the bearings of the pressure roller 21 because the bridging portion 32b is not formed.

As described above, the heater holder 23 and the flange 32 are designed to have dimensions in which a part of the opening of the flange 32 is narrower than a part of the heater holder 23. In other words, a part of the heater holder 23 and a part of the flange 32 are designed to have the length A of the longest portion of the heater holder 23 in the transverse direction that is larger than the length B of the narrowest part of the opening of the belt slide 32a of the flange 32. As a result, the heater holder 23 prevents the flange 32 from being closed inward.

Aspects of the present disclosure are, for example, as follows.

### (First Aspect)

In a first aspect, a fixing device includes a belt, a heater heating the belt, a holder holding the heater, a support supporting an end of the belt, an opposed member contacting an outer circumferential surface of the belt to form a nip. The fixing device in the first aspect has a feature that the support is partially widened by the holder when the support and the holder are assembled.

### (Second Aspect)

In a second aspect, the support in the fixing device according to the first aspect has a belt slide having a part overlapping a part of the holder when viewed in a rotational axis direction of the belt. The belt slide has an opening having the narrowest part at the part overlapping the part of the holder, and the narrowest part has a length B under a no-load state before the support is assembled. The part of the holder has the widest portion in the holder that has a length A under a no-load state before the holder is assembled, and the length A is larger than the length B.

### (Third Aspect)

In a third aspect, the fixing device according to the second aspect has a feature that (A−B) is equal to or shorter than 0.1 mm.

### (Fourth Aspect)

In a fourth aspect, the fixing device according to any one of the first to third aspects has a feature that a gap between the widest portion of the holder and the narrowest part of the opening of the belt slide changes depending on an insertion position of one of the support and the holder when the holder and the support are assembled. One of the support and the holder is inserted into another of the support and the holder.

### (Fifth Aspect)

In a fifth aspect, the fixing device according to the fourth aspect has a feature that the gap between the widest portion of the holder and the narrowest part of the opening of the belt slide of the support changes over a longitudinal direction of the holder.

### (Sixth Aspect)

In a sixth aspect, the fixing device according to the fourth aspect has a feature that the gap between the widest portion of the holder and the narrowest part of the opening of the belt slide of the support changes over a direction orthogonal to a longitudinal direction and a transverse direction of the holder.

### (Seventh Aspect)

In a seventh aspect, the fixing device according to any one of the second to sixth aspects has a feature that the holder and the support each have a projection having a tapered shape. The projection of the holder determines a length A at the widest portion of the holder, and the projection of the support determines a length B at the narrowest portion of the opening of the support.

### (Eighth Aspect)

In an eighth aspect, the fixing device according to any one of the first to seventh aspects has a feature that the widest portion of the holder and the narrowest part of the opening of the support are present, in a rotational axis direction of the belt, not only in the belt slide of the support overlapping the holder but also adjacent to a connection portion between a frame and the support.

### (Ninth Aspect)

In a ninth aspect, the fixing device according to any one of the first to seventh aspects has a feature that the support includes a bridging portion on a connection portion between a frame and the support.

### (Tenth Aspect)

In a tenth aspect, the fixing device according to any one of the first to eighth aspects has a feature that a gap between the heater and the holder in a region along the belt slide is larger than a gap between the heater and the holder in a region not along the belt slide.

### (Eleventh Aspect)

In an eleventh aspect, the fixing device according to any one of the first to tenth aspects has a feature that the bearing of the opposed member is a ball bearing.

### (Twelfth Aspect)

In a twelfth aspect, an image forming apparatus includes the fixing device according to any one of the first to eleventh aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A fixing device comprising:
a belt;
an opposed rotator contacting an outer circumferential surface of the belt to form a nip;
a heater to heat the belt;
a holder holding the heater, the holder extending in a longitudinal direction; and
a support supporting an end of the belt in the longitudinal direction, the support having a widened portion,
wherein the holder widens the widened portion of the support.

2. The fixing device according to claim 1,
wherein the support has a belt slide having:
an opening; and
the widened portion at least in a part of an edge of the opening,
the holder includes a widening portion in a part of the holder in the longitudinal direction,
the widening portion of the holder contacts the widened portion of the support and widens the widened portion,
the widening portion of the holder not disposed inside the support has a first length A in a transverse direction orthogonal to the longitudinal direction, and
the widened portion of the support, in which the holder is not disposed, has a second length B in the transverse direction shorter than the first length A at a position where the widening portion of the holder contacts the widened portion of the support.

3. The fixing device according to claim 1,
wherein the support has a belt slide having:
an opening; and
the widened portion at least in a part of an edge of the opening,
the holder includes a widening portion in a part of the holder in the longitudinal direction,
the widening portion of the holder contacts the widened portion of the support and widens the widened portion,
the widening portion of the holder not disposed inside the support has a longest length in a transverse direction orthogonal to the longitudinal direction, and
the widened portion of the support, in which the holder is not disposed, has a shortest length in the opening in the transverse direction shorter than the longest length.

4. The fixing device according to claim 2,
wherein the length A and the length B satisfy the following relationship.
(A−B)≤0.1 mm.

5. The fixing device according to claim 1,
wherein the widening portion of the holder has a first projection having a first height changing in an insertion direction in which the holder is inserted into the support or the support is inserted into the holder, and
the widened portion of the support has a second projection contacting with the first projection of the holder, the second projection has a second height changing in the insertion direction.

6. The fixing device according to claim 5,
wherein the first height of the first projection of the holder and the second height of the second projection of the support change in the longitudinal direction.

7. The fixing device according to claim 5,
wherein the holder extends in the longitudinal direction and a transverse direction orthogonal to the longitudinal direction, and
the first height of the first projection of the holder and the second height of the second projection of the support change in a direction orthogonal to the longitudinal direction and the transverse direction.

8. The fixing device according to claim 2,
wherein the widening portion of the holder has a projection having a tapered shape, and
the widened portion of the support has a projection having a tapered shape.

9. The fixing device according to claim 1, further comprising
a frame fitted to the support,
wherein the support has a belt slide, and
the widened portion of the support extends from the belt slide to a position adjacent to a position at which the frame is fitted to the support in the longitudinal direction.

10. The fixing device according to claim 1, further comprising
a frame fitted to the support,
wherein the support includes a bridging portion adjacent to a position at which the frame is fitted to the support.

11. The fixing device according to claim 1,
wherein the support has a belt slide, and
a gap between the heater and an edge of the holder adjacent to the belt slide is larger than a gap between the heater and the edge of the holder not adjacent to the belt slide.

12. The fixing device according to claim 1, further comprising
a ball bearing receiving a shaft of the opposed rotator.

13. An image forming apparatus comprising the fixing device according to claim 1.
